(19) United States
(12) Patent Application Publication
(10) Pub. No.: US 2001/0047821 A1
(43) Pub. Date: Dec. 6, 2001

(54) Apparatus for supplying chemical

(76) Inventor: Kunihiro Noji, Kanagawa (JP)

Correspondence Address: STETINA BRUNDA GARRED & BRUCKER, 75 ENTERPRISE, SUITE 250, ALISO VIEJO, CA, 92656, US

(21) Appl. No.: 09/867,149

(22) Filed: May 29, 2001

(30) Foreign Application Priority Data
Jun. 2, 2000 (JP) 2000-166093

(51) Int. Cl. G05D 11/00

(52) U.S. Cl. 137/87.02

(57) ABSTRACT

An apparatus stably supplying chemical to a treatment apparatus to resolve problems in semiconductor manufacturing process. The apparatus for supplying chemical according to the present invention handles chemical produced by one of methods of diluting a solution and mixing a plurality of solutions to a treatment apparatus and comprises: a plurality of means for storing the chemical; a main pipe for connecting respective chemical storing means and the treatment apparatus; means for supplying the chemical from respective chemical storing means to the treatment apparatus through the main pipe; a first circulation pipe for returning the chemical discharged from respective chemical storing means to the chemical storing means from which the chemical is discharged; and a second circulation pipe for returning the chemical which is transported immediately before the treatment apparatus by the chemical supplying means through the main pipe to the chemical storing means from which the chemical is discharged.

### CROSS-REFERENCE TO RELATED APPLICATIONS

The present application claims priority to Japanese Patent Application No. 2000-166093 entitled APPARATUS FOR SUPPLYING CHEMICAL filed on Jun. 2, 2000.

### STATEMENT RE: FEDERALLY SPONSORED RESEARCH/DEVELOPMENT

(Not Applicable)

### BACKGROUND OF THE INVENTION

The present invention relates to an apparatus for supplying a chemical, and more particularly to an apparatus for supplying a chemical, which is produced by diluting a solution, for instance, in semiconductor manufacturing process.

In semiconductor manufacturing processes, a variety of apparatus are used for produce chemical by diluting a solution with pure water or hydrogen peroxide, or mixing a plurality of undiluted solutions, and supply the produced chemical to treatment apparatus. For example, in wafer manufacturing process, a chemical for copper plating is used, and in wafer polishing process, slurry containing polishing particles is used. And, apparatus for supplying the plating solution, the slurry and the like are used in the wafer manufacturing process.

Such apparatus for supplying chemical is usually provided with diluting/mixing tanks in which a solution is diluted or a plurality of solutions are mixed, and storage tanks for storing chemical produce by the dilution or the mixture. A solution is diluted and mixed with pure water in the diluting/mixing tanks, and produced chemical is stored in the storage tanks. The chemical is supplied to a treatment apparatus at a predetermined rate in case of need. It is possible for a single tank to manage the dilution/mixture and the storage.

In semiconductor manufacturing processes, when the composition of the chemical supplied to the treatment apparatus is changed, or the size of particles contained in the chemical becomes large after the particles are gathered and hardened, the probability of defective semiconductor becomes high. For example, particles in a plating solution such as copper sulfate make the possibility of problems such as short circuit and wire breaking, high. When the size of polishing particles in slurry becomes large, problems including the scratch on a wafer occur. Therefore, apparatus stably supplying chemical are eagerly desired.

### BRIEF SUMMARY OF THE INVENTION

It is therefor the object of the present invention to provide an apparatus stably supplying chemical to a treatment apparatus to resolve problems in semiconductor manufacturing processes.

To accomplish the above objective, the apparatus for supplying chemical according to the present invention handles chemical produced by one of methods of diluting a solution and mixing a plurality of solutions to a treatment apparatus and comprises: a plurality of means for storing the chemical; a main pipe for connecting respective chemical storing means and the treatment apparatus; means for supplying the chemical from respective chemical storing means to the treatment apparatus through the main pipe; a first circulation pipe for returning the chemical discharged from respective chemical storing means to the chemical storing means from which the chemical is discharged; and a second circulation pipe for returning the chemical which is transported immediately before the treatment apparatus by the chemical supplying means through the main pipe to the chemical storing means from which the chemical is discharged.

With the above apparatus for supplying chemical according to the present invention, it is possible to circulate the chemicals discharged from respective chemical storing means through the first circulation pipe, and to circulate the chemical, which is discharged from respective chemical storing means and transported to the place just before the treatment apparatus through the main pipe and the chemical supplying means, through the second circulation pipe, without staying at a place, which prevents the changing of the composition of the chemical and prevents the particles contained in the chemical from being enlarged due to the hardening of the particles, resulting in stable feeding of the chemical.

In the above apparatus for supplying chemical according to the present invention, means for separately supplying the diluted solution and the diluting solution to the chemical storing means, or means for separately supplying the plurality of solutions to the chemical storing means may be installed. With this construction, the mixing of the undiluted solution and the diluting solution, or the mixing of the plurality of solutions can be carried out utilizing the chemical storing means and the first circulation pipe.

In the apparatus for supplying chemical according to the present invention, the chemical supplying means includes a plurality of pumps mounted to respective chemical storing means. With this construction, even if one pump becomes out of order, other pump can be operated to supply the chemical to the treatment apparatus, which prevents the stoppage of the supply of the chemical.

In the above apparatus for supplying chemical according to the present invention, it is possible to mount means for measuring the chemical stored in respective chemical storing means, and when the quantity of the chemical stored in the chemical storing means that supplies the chemical to the treatment apparatus becomes less than a predetermined value, the chemical can be supplied to other chemical storing means; or the diluted solution and the diluting solution can separately be supplied to other chemical storing means; or the plurality of solutions can separately be supplied to other chemical storing means. With this construction, the chemical is continuously supplied to the treatment apparatus.

In the above apparatus for supplying chemical according to the present invention, means for washing the first circulation pipe and the second circulation pipe may be installed, which prevents the chemical from staying at a place. As a result, the changing of the composition of the chemical and the enlarging of the particles contained in the chemical are securely prevented.

In the afore-mentioned apparatus for supplying chemical according to the present invention, every time the chemical is completely discharged from the chemical storing means from which the chemical is supplied to the treatment means, the chemical storing means can be washed by the washing means through the first circulation pipe. With this construction, the changing of the composition of the chemical and the enlarging of the size of particles contained in the chemical are much securely prevented.

In the apparatus for supplying chemical according to the present invention, the treatment apparatus may compose a semiconductor manufacturing apparatus. With this construction, in semiconductor manufacturing processes, the changing of the composition of the chemical and the enlarging of the particles contained in the chemical due to the hardening thereof are prevented, which solves the problems such as short circuit, wire breaking and the scratch on a wafer.

### BRIEF DESCRIPTION OF THE DRAWINGS

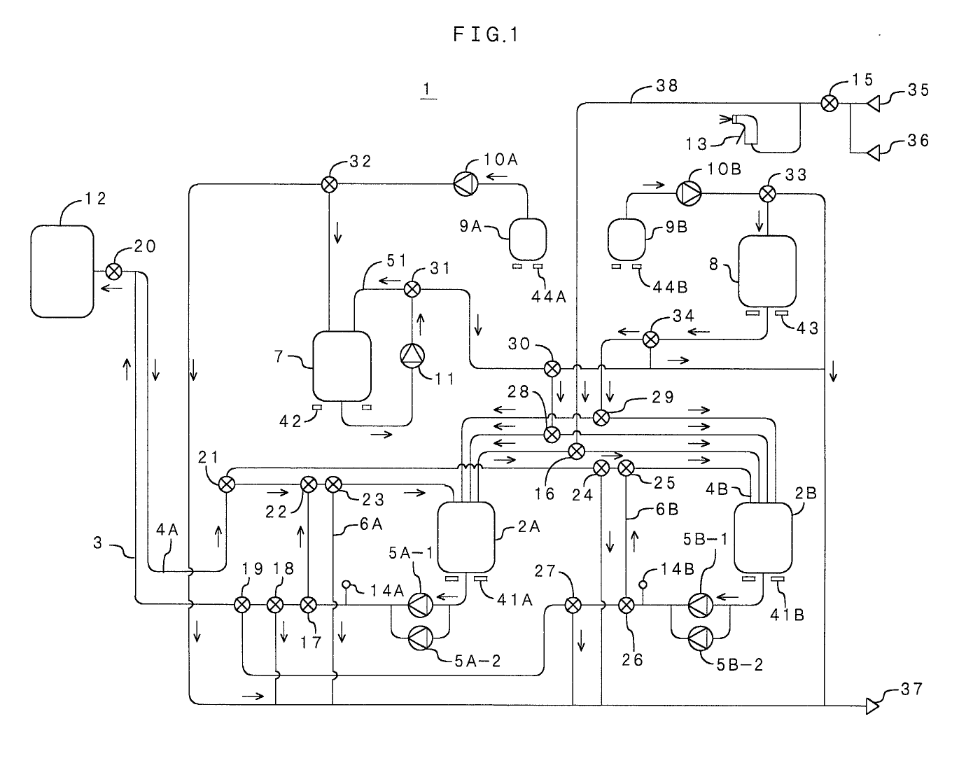

The present invention will be more apparent from the ensuring description with reference to FIG. 1 showing construction of the apparatus for supplying a chemical according to an embodiment of the present invention.

### DETAILED DESCRIPTION OF THE INVENTION

Now, a preferred embodiment of the present invention will be explained with reference to FIG. 1. In the explanation described below, a chemical produced by diluting slurry as an undiluted solution with hydrogen peroxide as a diluting solution is supplied to a treatment apparatus (polishing apparatus) in semiconductor manufacturing process. It is also possible to use the chemical supplying apparatus according to the present invention when a chemical produced by mixing a plurality of undiluted solutions is supplied to a treatment apparatus.

As illustrated in FIG. 1, the apparatus for supplying chemical according to one embodiment of the present invention comprises: mixing tanks 2 (2A, 2B) as a plurality of chemical storing means; a main pipe 3 connecting the tanks 2 and a treatment apparatus 12; pumps 5 (5A-1, 5A-2, 5B-1, 5B-2) as chemical supplying means; the first circulation pipes 6 (6A, 6B); the second circulation pipes 4 (4A, 4B) for returning chemical, which is transported to the place just before the treatment apparatus 12; an undiluted solution tank 7 temporarily storing the slurry; and a diluting solution tank 8 temporarily storing hydrogen peroxide.

To the mixing tank 2A are supplied the slurry and hydrogen peroxide from the undiluted solution tank 7 and the diluting solution tank 8 as described below, and a load cell 41A is installed to measure the quantity of the chemical in the mixing tank 2A. Two pumps 5A-1 and 5A-2 are installed to supply the chemical from the mixing tank 2A to the treatment apparatus 12, and a flow meter 14A is mounted downstream from the pumps 5A-1 and 5A-2. The reason why two pumps 5A-1 and 5A-2 are mounted is that even if one pump is out of order in operation, another pump can be used to continuously supply the chemical.

Between the mixing tank 2A and the treatment apparatus 12, besides the pumps 5A-1 and 5A-2 and the flow meter 14A, valves 17, 18, 19 are disposed. Further, the first circulation pipe 6A is mounted to return the chemical discharged from the mixing tank 2A to the mixing tank 2A again through the pumps 5A-1 and 5A-2. Still further, the second circulation pipe 4A is mounted to return the chemical transported to the place just before the treatment apparatus 12 through the main pipe 3 to the mixing tank 2A. To the second circulation pipe 4A are mounted valves 21, 22 and 23.

The mixing tank 2B is constructed in the same manner as the mixing tank 2A, slurry and hydrogen peroxide are supplied to the mixing tank 2B from the undiluted solution tank 7 and diluting solution tank 8, and a load cell 41B is mounted to measure the quantity of the chemical in the mixing tank 2B. Two pumps 5B-1 and 5B-2 are installed to supply the chemical to the treatment apparatus 12 from the mixing tank 2B, and a flow meter 14B is mounted downstream from the pumps 5B-1 and 5B-2. The reason why the two pumps 5B-1 and 5B-2 and the flow meter 14B are mounted is the same as explained above in connection with the mixing tank 2A.

Between the mixing tank 2B and the valve 19 on the main pipe 3, valves 26 and 27 are mounted. Further, the first circulation pipe 6B for returning the chemical discharged from the mixing tank 2B to the mixing tank 2B again through the pumps 5B-1 and 5B-2, and the second circulation pipe 4B for returning the chemical transported to the place just before the treatment apparatus 12 through the main pipe 3 to the mixing tank 2B are installed. To the second circulation pipe 4B are mounted valves 24 and 25.

The undiluted solution tank 7 is installed to temporally store the slurry as an undiluted solution, and a pump 11 is disposed to supply the slurry stored in the undiluted solution tank 7 to the mixing tanks 2A and 2B. Valves 31, 30 and 28 are mounted to a pipe connecting the undiluted solution tank 7, mixing tanks 2A and 2B. A load cell 42 is mounted to measure the quantity of the slurry in the undiluted solution tank 7, and a circulation pipe 51 is provided to circulate the slurry in the undiluted solution tank 7.

Upstream from the undiluted solution tank 7, a delivery tank 9A for slurry received from outside is placed, and between the delivery tank 9A and the undiluted solution tank 7 is installed a pump 10A for transporting the slurry in the delivery tank 9A to the undiluted solution tank 7. A valve 32 is mounted to a pipe connecting the delivery tank 9A and the undiluted solution tank 7.

On the other hand, the diluting solution tank 8 is installed to temporally store hydrogen peroxide as a diluting solution, and a load cell 43 is mounted to measure the quantity of hydrogen peroxide in the diluting solution tank 8. As for the diluting solution, it is unnecessary to provide a circulation route; therefore, no pump is mounted. The operation of the valves 34 and 29 allows the diluting solution to be supplied to the mixing tank 2A and 2B due to the weight of the diluting solution itself.

Upstream from the diluting solution tank 8, a delivery tank 9B for hydrogen peroxide received from outside is placed, and between the delivery tank 9B and the diluting solution tank 8 is installed a pump 10B for transporting hydrogen peroxide in the delivery tank 9B to the diluting solution tank 8. A valve 33 is mounted to a pipe connecting the delivery tank 9B and the diluting solution tank 8.

A pure water supply port 35, a nitrogen supply port 36, a flushing pipe 38 for supplying pure water and nitrogen, and a drain port 37 for each pipe are provided to wash the first circulation pipes 6A and 6B, the second circulation pipes 4A and 4B and so on. Nitrogen is used to dry the inner wall of pipes washed with pure water. A handy shower 13 is also installed to wash outer surface of each tank and pipe.

Next, the motion of the chemical supplying apparatus 1 with the above construction will be explained with reference to FIG. 1.

At first, from the delivery tanks 9A and 9B received from outside, slurry and hydrogen peroxide are supplied to the undiluted solution tank 7 and the diluting solution tank 8 through the pumps 10A and 10B. After the load cells 42 and 43 detect that the weights of the slurry and hydrogen peroxide in the undiluted solution tank 7 and the diluting solution tank 8 exceed predetermined values, the pump 10A and 10B stop. When the indications of the load cells 44A and 44B show the empty of the tanks 9A and 9B, the tanks 9A and 9B are replaced to new ones.

The slurry fed to the undiluted solution tank 7 circulates through the pump 11 and the circulation pipe 51 without staying at a place to prevent the size of particles in the slurry from becoming large. The circulation of the slurry is always carried out except when the slurry is fed to the mixing tank 2A and 2B.

Next, to the mixing tanks 2A and 2B are supplied the slurry and hydrogen peroxide from the undiluted solution tank 7 and the diluting solution 8. The slurry in the undiluted solution tank 7 is transported by changing the route of the valve 31 and operating the pump 11, and hydrogen peroxide in the diluting solution tank 8 is supplied by changing the routes of the valves 34 and 29 and utilizing the weight of the hydrogen peroxide itself.

The supply of the chemical from the mixing tank 2A to the treatment apparatus 12 is carried out by the operation of the pump 5A-1 or 5A-2. In order to stop the supply of the chemical to the treatment apparatus 12, the valve 20 is closed to return the chemical to the mixing tank 2A through the second circulation pipe 4A and the valves 21, 22 and 23. In this case, there is no need to stop the pump 5A-1 or 5A-2.

When the load cell 41A detects the condition just before the chemical in the mixing tank 2A is completely consumed, the pump 5A-1 or 5A-2 stops to supply the chemical from the mixing tank 2B to the treatment apparatus 12 by operating the pump 5B-1 or 5B-2.

On the other hand, to the empty mixing tank 2A is fed pure water from the pure water supply port 35 through the flushing pipe 38 and a valve 16 to wash the inside of the mixing tank 2A and the first circulation pipe 6A with the pure water. Dirty water after the washing is discharged from the drain port 37 through the valves 18, 19 and 27. Further, nitrogen is supplied from the nitrogen supply port 36 and clears pure water to dry the inside of the pipes and the like. As described above, every time the mixing tank 2 becomes empty, the mixing tank 2 is washed, so that the slurry does not stay in the mixing tank 2 or in the first circulation pipe 6 nor adhere thereto.

To the mixing tank 2A after washed are supplied the slurry and hydrogen peroxide from the undiluted solution tank 7 and the dilution solution tank 8 again as described above to standby the next feed of the chemical to the treatment apparatus 12.

It is also possible for the route of the second circulation pipes 4A and 4B to properly be washed with pure water and nitrogen supplied from the pure water supply port 35 and the nitrogen supply port 36 while the chemical is not supplied to the treatment apparatus 12.

In the above embodiment, two mixing tanks 2 and a treatment apparatus 12 are installed. But, it is a matter of course that more than three tanks 2 can be installed, and a plurality of treatment apparatus 12 may be provided.

1. An apparatus for supplying a chemical produced by one of a method of diluting a solution and mixing a plurality of solutions to a treatment apparatus, the apparatus comprising:
a plurality of means for storing the chemical;
a main pipe for connecting respective ones of the chemical storing means to the treatment apparatus;
means for supplying the chemical from respective ones of the chemical storing means to the treatment apparatus through the main pipe;
a first circulation pipe for returning the chemical discharged from any one of the chemical storing means to the chemical storing means from which the chemical is discharged; and
a second circulation pipe for returning the chemical which is transported toward the treatment apparatus by the chemical supplying means through the main pipe to the chemical storing means from which the chemical is discharged.

2. The apparatus for supplying a chemical as claimed in claim 1 further comprising one of means for separately supplying the diluted solution and the diluting solution to the chemical storing means and means for separately supplying the plurality of solutions to the chemical storing means.

3. The apparatus for supplying a chemical as claimed in claim 1, wherein the chemical supplying means includes a plurality of pumps mounted to respective ones of the chemical storing means.

4. The apparatus for supplying a chemical as claimed in claim 1 further comprising means for measuring the chemical stored in respective ones of the chemical storing means, wherein when a quantity of the chemical stored in the chemical storing means that supplies the chemical to the treatment apparatus becomes less than a predetermined value, one of a method of supplying the chemical to other chemical storing means, separately supplying the diluted solution and the diluting solution to the other chemical storing means, and separately supplying the plurality of solutions to the other chemical storing means, is performed.

5. The apparatus for supplying a chemical as claimed in claim 1 further comprising means for washing the first circulation pipe and the second circulation pipe.

6. The apparatus for supplying a chemical as claimed in claim 5, wherein the washing means is adapted to wash the chemical storing means through the first circulation pipe every time the chemical is completely discharged from the chemical storing means from which the chemical is supplied to the treatment means.

7. The apparatus for supplying a chemical as claimed in claim 1, wherein the treatment apparatus comprises a semiconductor manufacturing apparatus.

8. A method of supplying a chemical produced by one of a method of diluting a solution and mixing a plurality of solutions to a treatment apparatus, the method comprising the steps of:
a) supplying the chemical from respective ones of a plurality of chemical storing means to a treatment apparatus through a main pipe;
b) selectively returning the chemical discharged from any one of the chemical storing means to the chemical storing means from which the chemical is discharged via a first circulation pipe; and
c) selectively returning the chemical which is transported toward the treatment apparatus by the chemical supplying means through the main pipe to the chemical storing means from which the chemical is discharged via a second circulation pipe.

9. The method of claim 8 further comprising the steps of:
d) measuring the chemical stored in respective ones of the chemical storing means via a measuring means; and
e) supplying the chemical to other chemical storing means when a quantity of the chemical stored in the chemical storing means that supplies the chemical to the treatment apparatus becomes less than a predetermined value as determined by the measuring means.

10. The method of claim 8 further comprising the steps of:
d) measuring the chemical stored in respective ones of the chemical storing means via a measuring means; and
e) separately supplying the diluted solution and the diluting solution to other chemical storing means when a quantity of the chemical stored in the chemical storing means that supplies the chemical to the treatment apparatus becomes less than a predetermined value as determined by the measuring means.

11. The method of claim 8 further comprising the steps of:
d) measuring the chemical stored in respective ones of the chemical storing means via a measuring means; and
e) separately supplying the plurality of solutions to other chemical storing means when a quantity of the chemical stored in the chemical storing means that supplies the chemical to the treatment apparatus becomes less than a predetermined value as determined by the measuring means.

12. The method of claim 8 further comprising the step of:
d) washing the chemical storing means through the first circulation pipe via a washing means every time the chemical is completely discharged from the chemical storing means from which the chemical is supplied to the treatment means.
